(19) United States
(12) Patent Application Publication
(10) Pub. No.: US 2025/0148902 A1
(43) Pub. Date: May 8, 2025

(54) INTEGRATED SECURITY SYSTEM FOR SUBSTATION MONITORING AND DETECTION USING DISTRIBUTED ACOUSTIC SENSING, DRONES, AND SECURITY CAMERAS

(71) Applicant: NEC Laboratories America, Inc., Princeton, NJ (US)

(72) Inventors: Yangmin DING, East Brunswick, NJ (US); Ting WANG, West Windsor, NJ (US); Yue TIAN, Princeton, NJ (US); Sarper OZHARAR, Pennington, NJ (US); Zhuocheng JIANG, Plainsboro, NJ (US); Yanchao WANG, Princeton, NJ (US)

(73) Assignee: NEC Laboratories America, Inc., Princeton, NJ (US)

(21) Appl. No.: 18/935,489

(22) Filed: Nov. 2, 2024

Related U.S. Application Data
(60) Provisional application No. 63/595,825, filed on Nov. 3, 2023.

(51) Int. Cl. G08B 25/14; G01H 9/00; G06V 20/52

(52) U.S. Cl. CPC G08B 25/14; G01H 9/004; G06V 20/52

(57) ABSTRACT

Disclosed are integrated systems and operating methods that provide an integrated security system for substation monitoring and detection that effectively combines the strengths of distributed acoustic sensing, drones, and security cameras for comprehensive protection. The integrated system comprises a DAS system configured to monitor vibrations and acoustic signals along the length of fiber optic cables, one or more drones equipped with advanced sensors for aerial surveillance, and a plurality of security cameras installed throughout the substation to capture real-time video feeds and provide visual confirmation of activities. A central control system integrates and analyzes data from the DAS system, drones, and security cameras, and utilizes a novel, advanced algorithm, named Substation Security Analytics (SSA), specifically designed for the unique challenges associated with substation security monitoring and detection.

### CROSS-REFERENCE TO RELATED APPLICATIONS

This application claims the benefit of U.S. Provisional Patent Application Ser. No. 63/595,825 filed Nov. 3, 2023, the entire contents of which is incorporated by reference as if set forth at length herein.

### FIELD OF THE INVENTION

This application relates generally to distributed fiber optic sensing (DFOS) systems, methods, structures, and related technologies. More particularly, it pertains to integrated security systems for substation monitoring and detection using distributed acoustic sensing (DAS), drones, and security cameras.

### BACKGROUND OF THE INVENTION

Distributed fiber optic sensing (DFOS) systems, methods, and structures have found widespread utility in contemporary industry and society. Of particular importance, DFOS techniques have been used to usher in a new era of monitoring including perimeter security, traffic monitoring, and civil infrastructure monitoring.

Power utility substations are critical components of the electricity distribution infrastructure, responsible for the transmission, distribution, and transformation of electrical energy. Ensuring their security is of paramount importance due to the economic, social, and environmental consequences of disruptions caused by equipment failure, theft, vandalism, or sabotage. As the demand for electricity continues to grow, and power systems become more complex and interconnected, the need for advanced security solutions for substations becomes increasingly important.

Conventional security measures for substations have included physical barriers such as fences and walls, security guards, standalone security cameras, and simple intrusion detection systems. While these measures can provide a basic level of security, they have several limitations.

Coverage: Standalone security cameras and intrusion detection systems may not provide comprehensive coverage of the entire substation area, leaving blind spots that could be exploited by potential intruders. Additionally, security guards can only patrol a limited area and may not be able to detect or respond to incidents occurring in remote or hidden areas of the substation.

Efficiency: Manually monitoring security camera feeds or patrolling the substation perimeter can be labor-intensive and time-consuming for security personnel, reducing their ability to respond to incidents promptly and effectively.

Adaptability: Conventional security measures may not be well-suited to adapt to different situations or environmental conditions, such as inclement weather, low-light conditions, or varying levels of activity at the substation. This can result in reduced effectiveness of the security system and an increased likelihood of false alarms or missed incidents.

Integration: Standalone security measures may not be well-integrated, requiring security personnel to monitor and manage multiple systems simultaneously. This lack of integration can hinder the rapid identification and assessment of potential security threats, further delaying the response to incidents.

### SUMMARY OF THE INVENTION

The above problems are solved and an advance in the art is made according to aspects of the present disclosure directed to systems and methods providing comprehensive protections for substations, overcoming the limitations of conventional security measures.

In sharp contrast to the prior art, systems and methods according to aspects of the present disclosure achieve such solutions and advances in the art by integrating advanced technologies such as distributed acoustic sensing (DAS), drones, and security cameras for enhanced monitoring, detection, and response capabilities.

As we shall show and describe systems and methods according to aspects of the present disclosure advantageously provide an integrated security system for substation monitoring and detection that effectively combines the strengths of distributed acoustic sensing (DAS), drones, and security cameras for comprehensive protection. The integrated security system comprises the following interoperating components.

A DAS system configured to monitor vibrations and acoustic signals along the length of fiber optic cables. The DAS system may be installed along a substation perimeter, as well as around critical equipment within the substation. This advantageously enables the detection of attempted breaches, equipment tampering, or potential equipment failure, providing real-time alerts to any unusual activity.

One or more drones equipped with advanced sensors for aerial surveillance. These drones enable rapid response to incidents, providing expanded coverage of the substation and its surroundings. These drones can be equipped with sensors such as infrared, thermal imaging, or light detecting and ranging (LIDAR) sensors, allowing them to detect potential security threats in various environmental conditions and at different times of day.

A plurality of security cameras installed throughout the substation to capture real-time video feeds and provide visual confirmation of activities. The security cameras can have advanced features such as pan-tilt-zoom (PTZ) capabilities for wide-area coverage, infrared or thermal imaging for low-light conditions, and weather-resistant enclosures for protection against adverse weather.

A central control system for integrating and analyzing data from the DAS system, drones, and security cameras. The central control system utilizes a novel advanced algorithm, named Substation Security Analytics (SSA), specifically designed for the unique challenges associated with substation security monitoring and detection. The SSA algorithm incorporates artificial intelligence (AI) and machine learning (ML) techniques to process the collected data and identify potential security threats. The SSA algorithm is based on a multi-modal fusion approach, which combines data from the DAS system, drones, and security cameras in a complementary manner. The algorithm first extracts relevant features from the raw data, such as acoustic signatures, visual cues, and motion patterns. It then applies AI and ML techniques, such as deep learning and decision trees, to classify the extracted features and detect potential security threats. The algorithm advantageously learns from historical data, allowing it to adapt and improve its performance over time.

Anomaly detection and pattern recognition: The SSA algorithm according to the present disclosure includes advanced algorithms that can identify unusual activities or patterns, such as trespassing or potential equipment failure, by analyzing historical data and establishing baseline behavior.

Automated drone dispatch: The integrated security system according to the present disclosure can automatically dispatch drones for surveillance in response to specific triggers or detected threats, ensuring timely assessment and response to potential incidents.

Dynamic adaptation of surveillance: The integrated security system according to the present disclosure can dynamically adjust the surveillance coverage of the drones and security cameras based on the identified threat levels, environmental conditions, or predefined schedules.

Collaborative data sharing between substations: The integrated security system according to the present disclosure establishes a secure communication network that enables data sharing between different substations, allowing for better overall situational awareness and more efficient responses to potential security threats.

### BRIEF DESCRIPTION OF THE DRAWING

FIG. 1(A) and FIG. 1(B) are schematic diagrams showing an illustrative prior art uncoded and coded DFOS systems.

FIG. 2 is a schematic flow diagram showing illustrative advanced features and operation of systems and methods according to aspects of the present disclosure.

FIG. 3 is a schematic flow diagram showing illustrative operational flow of systems and methods according to aspects of the present disclosure.

FIG. 4 is a schematic feature diagram in hierarchical format showing illustrative features of systems and methods according to aspects of the present disclosure.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing systems convert the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

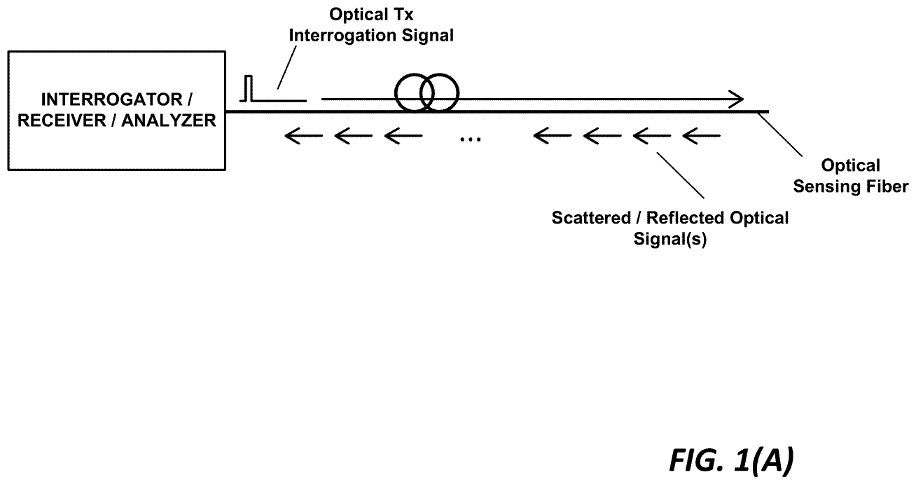

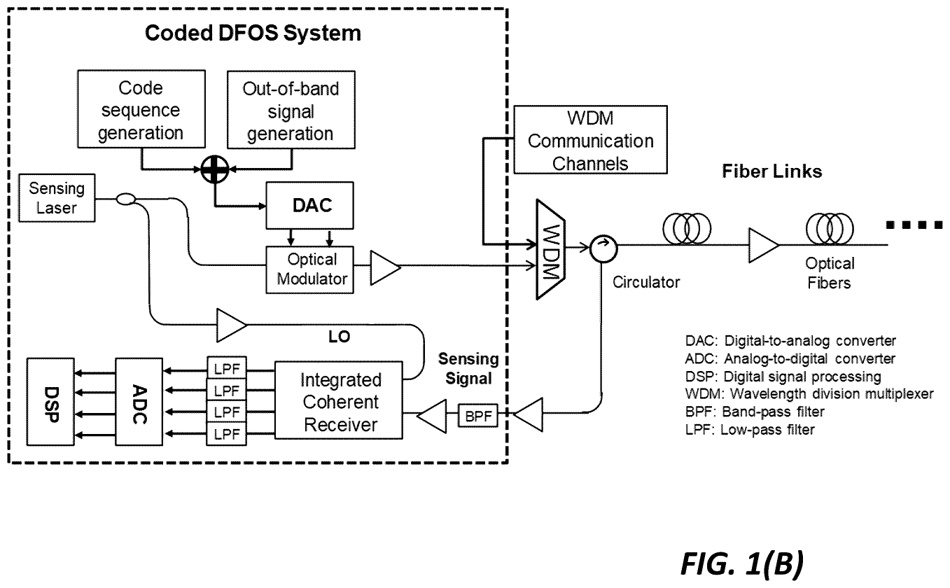

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detects/analyzes reflected/backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Of particular interest, distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows for continuous monitoring over long distances, but instead of measuring temperature, it measures vibrations and sounds along the fiber.

DAS/DVS operates as follows.

Light pulses are sent through the fiber optic sensor cable.

As the light travels through the cable, vibrations and sounds cause the fiber to stretch and contract slightly.

These tiny changes in the fiber's length affect how the light interacts with the material, causing a shift in the backscattered light's frequency.

By analyzing the frequency shift of the backscattered light, the DAS/DVS system can determine the location and intensity of the vibrations or sounds along the fiber optic cable.

Similar to DTS, DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technology has a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

With the above in mind, we note again that a motivating application of systems and methods according to aspects of the present disclosure is critical infrastructure monitoring and in particular power station/substation monitoring with integrated systems and methods including distributed acoustic sensing (DAS), drones, and security cameras for enhanced monitoring, detection, and response capabilities.

As we shall show and describe systems and methods according to aspects of the present disclosure advantageously provide an integrated security system and operational method for substation monitoring and detection that effectively combines the strengths of distributed acoustic sensing (DAS), drones, and security cameras for comprehensive protection. The integrated security system comprises the following interoperating components.

A DAS system configured to monitor vibrations and acoustic signals along the length of fiber optic cables. The DAS system may be installed along a substation perimeter, as well as around critical equipment within the substation. This advantageously enables the detection of attempted breaches, equipment tampering, or potential equipment failure, providing real-time alerts to any unusual activity.

One or more drones equipped with advanced sensors for aerial surveillance. These drones enable rapid response to incidents, providing expanded coverage of the substation and its surroundings. These drones can be equipped with sensors such as infrared, thermal imaging, or light detecting and ranging (LiDAR) sensors, allowing them to detect potential security threats in various environmental conditions and at different times of day.

A plurality of security cameras installed throughout the substation to capture real-time video feeds and provide visual confirmation of activities. The security cameras can have advanced features such as pan-tilt-zoom (PTZ) capabilities for wide-area coverage, infrared or thermal imaging for low-light conditions, and weather-resistant enclosures for protection against adverse weather.

A central control system for integrating and analyzing data from the DAS system, drones, and security cameras. The central control system utilizes a novel advanced algorithm, named Substation Security Analytics (SSA), specifically designed for the unique challenges associated with substation security monitoring and detection. The SSA algorithm incorporates artificial intelligence (AI) and machine learning (ML) techniques to process the collected data and identify potential security threats. The SSA algorithm is based on a multi-modal fusion approach, which combines data from the DAS system, drones, and security cameras in a complementary manner. The algorithm first extracts relevant features from the raw data, such as acoustic signatures, visual cues, and motion patterns. It then applies AI and ML techniques, such as deep learning and decision trees, to classify the extracted features and detect potential security threats. The algorithm advantageously learns from historical data, allowing it to adapt and improve its performance over time.

Anomaly detection and pattern recognition: The SSA algorithm according to the present disclosure includes advanced algorithms that can identify unusual activities or patterns, such as trespassing or potential equipment failure, by analyzing historical data and establishing baseline behavior.

Automated drone dispatch: The integrated security system according to the present disclosure can automatically dispatch drones for surveillance in response to specific triggers or detected threats, ensuring timely assessment and response to potential incidents.

Dynamic adaptation of surveillance: The integrated security system according to the present disclosure can dynamically adjust the surveillance coverage of the drones and security cameras based on the identified threat levels, environmental conditions, or predefined schedules.

Collaborative data sharing between substations: The integrated security system according to the present disclosure establishes a secure communication network that enables data sharing between different substations, allowing for better overall situational awareness and more efficient responses to potential security threats.

Particularly inventive aspects of systems and methods according to aspects of the present disclosure include the following.

Integration of distributed acoustic sensing (DAS), drones, and security cameras: This combination of technologies provides comprehensive coverage and monitoring capabilities, addressing the limitations of traditional security measures.

Multi-modal fusion approach in the Substation Security Analytics (SSA) algorithm: By combining data from the DAS system, drones, and security cameras in a complementary manner, the algorithm can effectively analyze and identify potential security threats.

Use of artificial intelligence (AI) and machine learning (ML) techniques in the SSA algorithm: These techniques enable the system to adapt and improve its performance over time, resulting in a more accurate and efficient security solution.

Advanced sensors on drones: Equipping drones with infrared, thermal imaging, or LiDAR sensors allows for enhanced detection capabilities in various environmental conditions and at different times of day.

Advanced features in security cameras: Incorporating pan-tilt-zoom (PTZ) capabilities, infrared or thermal imaging, and weather-resistant enclosures ensures wide-area coverage, low-light detection, and protection against adverse weather.

Anomaly detection and pattern recognition: The SSA algorithm incorporates advanced algorithms that can identify unusual activities or patterns, such as trespassing or potential equipment failure, by analyzing historical data and establishing baseline behavior.

Automated drone dispatch: The integrated security system can automatically dispatch drones for surveillance in response to specific triggers or detected threats, ensuring timely assessment and response to potential incidents.

Dynamic adaptation of surveillance: The integrated security system can dynamically adjust the surveillance coverage of the drones and security cameras based on the identified threat levels, environmental conditions, or predefined schedules.

Collaborative data sharing between substations: The integrated security system establishes a secure communication network that enables data sharing between different substations, allowing for better overall situational awareness and more efficient responses to potential security threats.

By incorporating these inventive features, integrated security systems and methods according to aspects of the present disclosure effectively address challenges associated with substation security monitoring and detection, providing comprehensive protection and enhancing the overall reliability of the power distribution system.

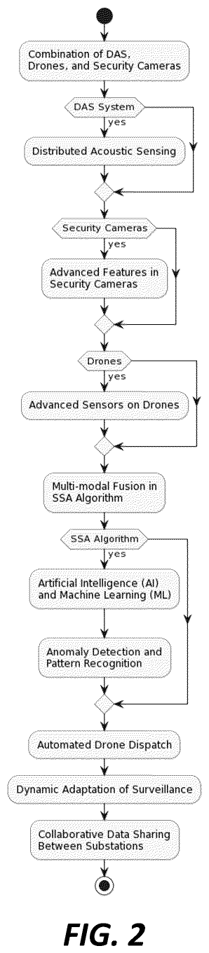

FIG. 2 is a schematic flow diagram showing illustrative advanced features and operation of systems and methods according to aspects of the present disclosure. An illustrative step by step description of the operation of systems and methods according to the present disclosure includes the following.

### Step 1: Set Up the DAS System

Assess the substation layout and identify critical areas that require monitoring.

Install fiber optic cables along the substation perimeter and around critical equipment within the substation, ensuring proper cable routing and protection.

Connect the DAS system to the fiber optic cables and configure it to continuously monitor vibrations and acoustic signals.

Perform initial calibration and testing to ensure optimal performance.

### Step 2: Install Security Cameras

Conduct a site survey to identify strategic locations for security camera installation, considering factors such as coverage, visibility, and potential blind spots.

Install security cameras with advanced features, ensuring proper mounting, alignment, and secure connections.

Connect the cameras to the central control system and configure them for continuous monitoring and recording.

Test the camera feeds to ensure proper image quality, coverage, and functionality.

### Step 3: Deploy Drones

Select appropriate drone models with the necessary payload capacity and flight endurance to carry advanced sensors and cover the required surveillance area.

Equip the drones with advanced sensors such as infrared, thermal imaging, or LiDAR sensors to enable detection of potential security threats in various environmental conditions and at different times of day.

Establish a secure and convenient storage location within the substation for easy drone access when required.

Configure the drones to communicate with the central control system and test their functionality.

### Step 4: Set Up the Central Control System

Set up the hardware and software infrastructure required for the central control system, including servers, networking equipment, and user interfaces.

Configure the central control system to integrate data from the DAS system, drones, and security cameras for real-time analysis.

Test the central control system to ensure proper data integration, processing, and functionality.

### Step 5: SSA Algorithm Development

Develop and implement the SSA algorithm, which utilizes machine learning techniques to process the collected data and identify potential security threats. The SSA algorithm should be based on a multi-modal fusion approach, which combines data from the DAS system, drones, and security cameras in a complementary manner. The algorithm should first extract relevant features from the raw data, such as acoustic signatures, visual cues, and motion patterns. It should then apply AI and ML techniques, such as deep learning and decision trees, to classify the extracted features and detect potential security threats. The algorithm should be capable of learning from historical data, allowing it to adapt and improve its performance over time.

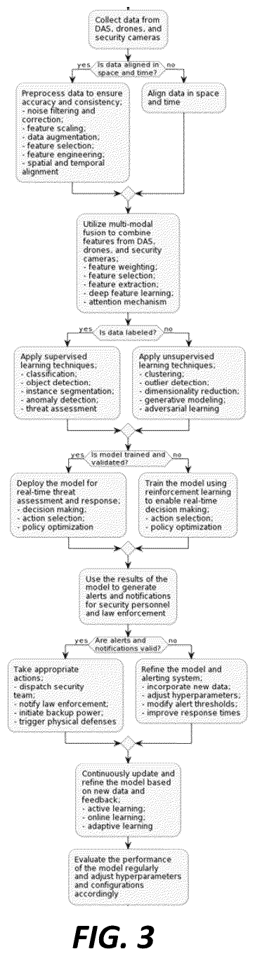

FIG. 3 is a schematic flow diagram showing illustrative SSA operational flow of systems and methods according to aspects of the present disclosure. With reference to that figure, the following operational flow is performed.

Collect data from DAS, drones, and security cameras: The first step in the SSA algorithm is to collect data from various sources, including distributed acoustic sensing (DAS) systems, drones, and security cameras. These data sources capture different types of information, such as acoustic signals, visual cues, and motion patterns, that can be used to detect potential security threats.

Preprocess data to ensure accuracy and consistency: Before the collected data can be used for threat detection, it must be preprocessed to ensure accuracy and consistency. This includes applying techniques such as noise filtering and correction, feature scaling, data augmentation, feature selection, feature engineering, and spatial and temporal alignment.

Utilize multi-modal fusion to combine features from DAS, drones, and security cameras: Once the data has been preprocessed, the next step is to use multi-modal fusion to combine features from the different data sources. This involves feature weighting, feature selection, feature extraction, deep feature learning, and attention mechanisms.

Apply supervised or unsupervised learning techniques: Depending on whether the collected data is labeled or not, the SSA algorithm can apply supervised or unsupervised learning techniques. Supervised learning techniques include classification, object detection, instance segmentation, anomaly detection, and threat assessment, while unsupervised learning techniques include clustering, outlier detection, dimensionality reduction, generative modeling, and adversarial learning.

Deploy the model for real-time threat assessment and response: Once the model has been trained and validated, it can be deployed for real-time threat assessment and response. This involves decision making, action selection, and policy optimization.

Use the results of the model to generate alerts and notifications for security personnel and law enforcement: The results of the model can be used to generate alerts and notifications for security personnel and law enforcement. This allows them to take appropriate actions, such as dispatching a security team, notifying law enforcement, initiating backup power, or triggering physical defenses.

Continuously update and refine the model based on new data and feedback: The SSA algorithm should be continuously updated and refined based on new data and feedback. This includes using techniques such as active learning, online learning, and adaptive learning to improve the accuracy and effectiveness of the model over time.

Evaluate the performance of the model regularly and adjust hyperparameters and configurations accordingly: Finally, the performance of the model should be evaluated regularly, and hyperparameters and configurations should be adjusted accordingly. This ensures that the model remains accurate and effective in detecting potential security threats.

### Step 6: Alert and Notification System

Develop an alert and notification system that generates alarms or alerts based on predefined criteria and sends notifications to security personnel or law enforcement as necessary. Configure the alert and notification system to be responsive and timely, ensuring that potential security threats are identified and addressed promptly. Develop and test communication protocols and response plans to ensure that the appropriate parties are notified and action is taken in the event of an incident.

### Step 7: Incident Response Procedures

Once the SSA algorithm generates alerts and notifications, the incident response procedures come into play. The incident response procedures involve a set of guidelines and protocols that define how to respond to security incidents in the substation. The incident response procedures should be well-defined and clearly communicated to all relevant personnel, including security staff, operations staff, and management. The procedures should cover a wide range of scenarios, including breaches, equipment tampering, vandalism, theft, and natural disasters.

The incident response procedures should include the following steps:

Verify the alert: Once an alert is generated, the first step is to verify the alert to ensure that it is a legitimate threat. This involves reviewing the data collected by the DAS, drones, and security cameras and comparing it to the SSA algorithm's output.

Notify the relevant personnel: Once the alert has been verified, the relevant personnel should be notified immediately. This includes security staff, operations staff, and management, as well as law enforcement agencies if necessary.

Assess the situation: The next step is to assess the situation and determine the severity of the threat. This includes evaluating the potential impact on the substation's operations, equipment, and personnel, as well as the potential risk to public safety and the environment.

Initiate appropriate response measures: Based on the severity of the threat, appropriate response measures should be initiated. This may include dispatching a security team, notifying law enforcement, initiating backup power, or triggering physical defenses.

Document the incident: Once the incident has been resolved, it should be documented in detail. This includes recording the date and time of the incident, the type of incident, the actions taken, and the outcome.

Review and update the incident response procedures: Finally, the incident response procedures should be reviewed and updated regularly to ensure that they remain up-to-date and effective. This includes incorporating lessons learned from previous incidents and incorporating new security technologies and best practices.

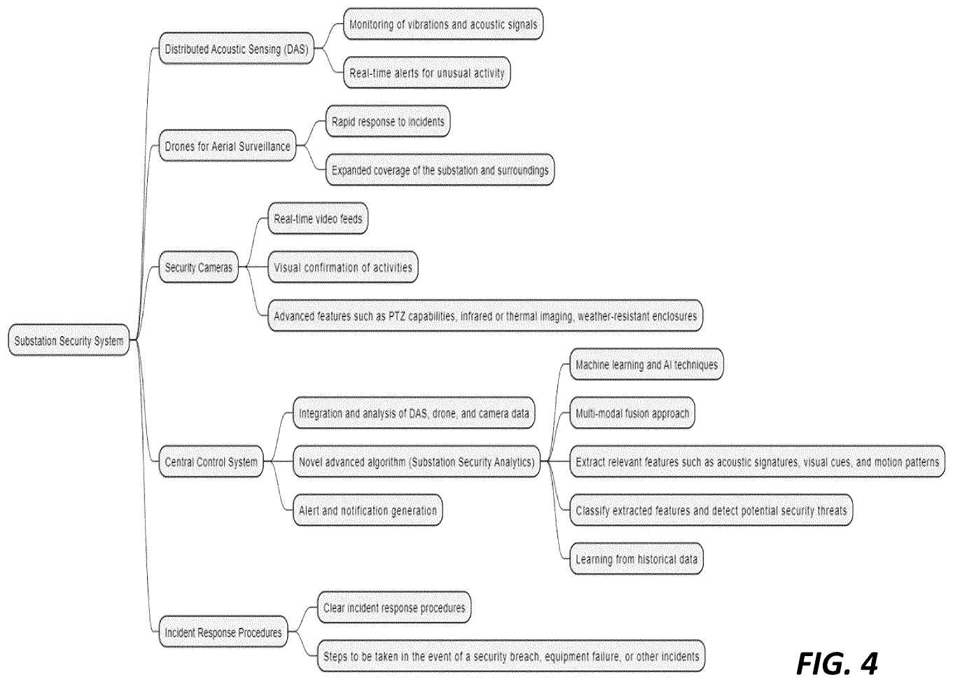

FIG. 4 is a schematic feature diagram in hierarchical format showing illustrative features of systems and methods according to aspects of the present disclosure.

While we have presented our inventive concepts and description using specific examples, our invention is not so limited. Accordingly, the scope of our invention should be considered in view of the following claims.

1. An integrated security system comprising:
a distributed fiber optic sensing system;
one or more aerial drones; and
one or more security cameras;
wherein the integrated security system is configured to receive, integrate, and analyze data produced by the distributed fiber optic sensing system, the one or more aerial drones, and the one or more security cameras.

2. The system of claim 1 wherein the distributed fiber optic sensing system (DFOS) is a distributed acoustic sensing/distributed vibration sensing (DAS/DVS) system.

3. The system of claim 2 wherein the one or more aerial drones provide real-time video feeds for visual confirmation of incidents.

4. The system of claim 3 wherein the one or more security cameras provide real-time video feeds for visual confirmation of activities.

5. The system of claim 4 configured to provide machine learning and artificial intelligence techniques to the data received from the distributed fiber optic sensing system, the one or more aerial drones, and the one or more security cameras.

6. The system of claim 5 configured to extract relevant features from the received data including acoustic signatures, visual cues, and motion patterns.

7. The system of claim 6 configured to classify the extracted relevant features.

8. The system of claim 7 configured to detect potential security threats from the classified extracted relevant features.

9. The system of claim 8 configured to learn from historical data received from the distributed fiber optic sensing system, the one or more aerial drones, and the one or more security cameras.

10. The system of claim 9 configured to respond to detected potential security threats by initiating incident response procedures.
